(19) United States
(12) Patent Application Publication
(10) Pub. No.: US 2011/0103643 A1
(43) Pub. Date: May 5, 2011

(54) IMAGING SYSTEM WITH INTEGRATED IMAGE PREPROCESSING CAPABILITIES

(76) Inventors: Kenneth Edward Salsman, Pleasanton, CA (US); Nicholas E. Brathwaite, Pleasanton, CA (US); Bob Gove, Los Gatos, CA (US)

(21) Appl. No.: 12/721,525

(22) Filed: Mar. 10, 2010

Related U.S. Application Data
(60) Provisional application No. 61/257,437, filed on Nov. 2, 2009.

(51) Int. Cl. G06K 9/62; H04N 5/225; H04N 5/217; G01S 19/41

(52) U.S. Cl. 382/103; 348/372; 348/241; 348/E05.078; 348/E05.024

(57) ABSTRACT

An electronic device may have a camera module. The camera module may include a camera sensor and associated image preprocessing circuitry. The image preprocessing circuitry may analyze images from the camera module to perform motion detection, facial recognition, and other operations. The image preprocessing circuitry may generate signals that indicate the presence of a user and that indicate the identity of the user. The electronic device may receive the signals from the camera module and may use the signals in implementing power saving functions. The electronic device may enter a power conserving mode when the signals do not indicate the presence of a user, but may keep the camera module powered in the power conserving mode. When the camera module detects that a user is present, the signals from the camera module may activate the electronic device and direct the electronic device to enter an active operating mode.

This application claims the benefit of provisional patent application No. 61/257,437, filed Nov. 2, 2009, which is hereby incorporated by reference herein in its entirety.

### BACKGROUND

The present invention relates to imaging systems and, more particularly, to imaging systems with integrated image processing capabilities.

Electronic devices such as cellular telephones, camera, and computers often use digital camera modules to capture images. The electronic devices typically include image processing circuitry that is separate from the digital camera modules. Users of these devices are increasingly demanding advanced image processing capabilities. As one example of an image processing capability, an electronic device with image processing circuitry may process captured images with the image processing circuitry to track the motion of an object in the images.

Although such systems may be satisfactory in certain circumstances, the use of image processing circuitry separate from digital camera modules poses challenges. For example, because the image processing circuitry receives complete images from the digital camera modules, the image processing circuitry has to be relatively powerful and cannot be shutdown during power saving modes without sacrificing functionality. These limitations tend to increase the cost and complexity of imaging systems in which image processing circuitry is used.

### BRIEF DESCRIPTION OF THE DRAWINGS

FIG. 1 is a diagram of an electronic device that may include a camera module and host subsystem in accordance with an embodiment of the present invention.

FIG. 2 is a flow chart of illustrative steps involved in using an imaging system with image preprocessing capabilities to awaken an electronic device from a power-conservation state in accordance with an embodiment of the present invention.

FIGS. 3 and 4 are graphs of the illustrative power consumption of an electronic device that uses an imaging system with image preprocessing capabilities as part of a power conservation scheme in accordance with an embodiment of the present invention.

FIG. 5 is a flow chart of illustrative steps involved in using an imaging system with image preprocessing capabilities in an image-based positioning system in accordance with an embodiment of the present invention.

FIG. 6 is a flow chart of illustrative steps involved in using an imaging system with image preprocessing capabilities in an image identification system in accordance with an embodiment of the present invention.

FIG. 7 is a flow chart of illustrative steps involved in using an imaging system with image preprocessing capabilities in a projection system in accordance with an embodiment of the present invention.

FIG. 8 is a flow chart of illustrative steps involved in using an imaging system with image preprocessing capabilities to provide one or more preprocessed images to a host subsystem in accordance with an embodiment of the present invention.

FIG. 9 is a diagram of an illustrative camera module that may capture images and provide image data to a camera system in accordance with an embodiment of the present invention.

### DETAILED DESCRIPTION

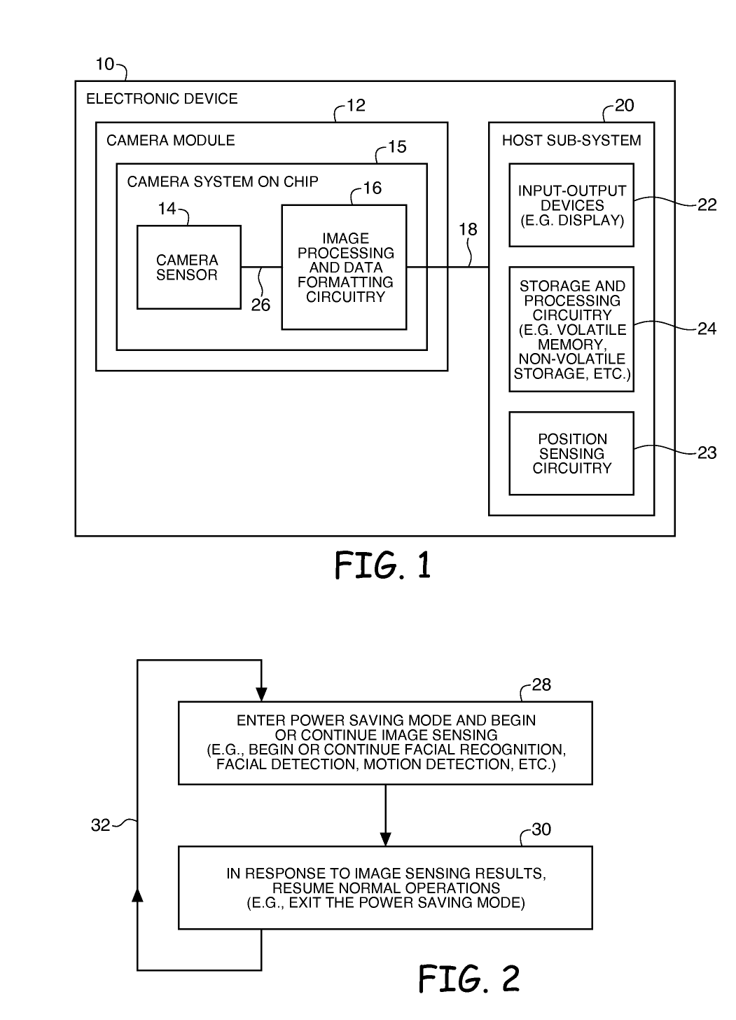

Digital camera modules are widely used in electronic devices. An electronic device with a digital camera module is shown in FIG. 1. Electronic device 10 may be a digital camera, a computer, a cellular telephone, or other electronic device. Imaging system 12 (e.g., camera module 12) may include an image sensor 14 and a lens. During operation, the lens focuses light onto image sensor 14. The pixels in image sensor 14 include photosensitive elements that convert the light into digital data. Image sensors may have any number of pixels (e.g., hundreds or thousands or more). A typical image sensor may, for example, have millions of pixels (e.g., megapixels). In high-end equipment, sensors with 10 megapixels or more are not uncommon.

Still and video image data from camera sensor 14 may be provided to image processing and data formatting circuitry 16 via path 26. Image processing and data formatting circuitry 16 may be used to perform image processing functions such as adjusting white balance and exposure and implementing video image stabilization, image cropping, image scaling, etc. Image processing and data formatting circuitry 16 may also be used to compress raw camera image files if desired (e.g., to Joint Photographic Experts Group or JPEG format).

If desired, image processing and data formatting circuitry 16 may be used to perform image preprocessing functions. The image preprocessing functions that may be performed by circuitry 16 include brightness measurements, ambient light measurements, colorimetric measurements, motion detection, object tracking, face detection, facial tracking, gesture tracking, gesture recognition, object recognition, facial recognition, graphical overlay operations such as avatar processing operations, optical character recognition (OCR) preprocessing and processing, image cropping operations, projector autofocus calculations, projector zoom calculations, projector keystone calculations, image preprocessing for indoor positioning systems, other functions, and combinations of these and other functions.

In a typical arrangement, which is sometimes referred to as a system on chip or SOC arrangement, camera sensor 14 and image processing and data formatting circuitry 16 are implemented on a common integrated circuit 15. The use of a single integrated circuit to implement camera sensor 14 and image processing and data formatting circuitry 16 can help to minimize costs. If desired, however, multiple integrated circuits may be used to implement circuitry 15.

Circuitry 15 conveys data to host subsystem 20 over path 18. Circuitry 15 may provide acquired image data such as captured video and still digital images to host subsystem 20. If desired, circuitry 15 may provide host subsystem 20 with data generated by image processing circuitry 16 such as brightness information, ambient light information, colorimetric information, motion detection flags, object tracking information such as the time-varying coordinates of an object, face detection flags (i.e., interrupts), facial tracking information, gesture tracking information, gesture flags, object identification information, facial identification information, processed avatar image data (e.g., image data with one or more overlaid avatar images), image data preprocessed for OCR processing (e.g., high contrast image data) and/or OCR text output, cropped image data (e.g., image data cropped around detected objects and/or faces), projector control information (e.g., information on focus corrections, keystone corrections, colorimetric corrections, brightness corrections, etc.), preprocessed image data for indoor positioning systems, etc.

Electronic device 10 typically provides a user with numerous high level functions. In a computer or advanced cellular telephone, for example, a user may be provided with the ability to run user applications. To implement these functions, electronic device 10 may have input-output devices 22 such as projectors, keypads, input-output ports, and displays and storage and processing circuitry 24. Storage and processing circuitry 24 may include volatile and nonvolatile memory (e.g., random-access memory, flash memory, hard drives, solid state drives, etc.). Storage and processing circuitry 24 may also include processors such as microprocessors, microcontrollers, digital signal processors, application specific integrated circuits, etc.

Device 10 may include position sensing circuitry 23. Position sensing circuitry 23 may include, as examples, global positioning system (GPS) circuitry and radio-frequency-based positioning circuitry (e.g., cellular-telephone positioning circuitry).

Control of the operational power mode of systems (e.g., electronic devices 10) that are designed for human interface such as personal computers, facility systems, and other appliance/functional systems is possible with the use of camera module 12 to detect either a face of a person or a specific amount or type of motion in its field of view. A relatively small amount of logic 16 may be incorporated on the imaging array silicon such as an SOC or co-processor in a combined package 15 to detect a face or characteristic motion. Logic 16 may work with a software program executed on processing circuitry 24 to place electronic device 10 in a progressive series of power saving modes. Device 10 need only provide power to camera module 12 (e.g. via USB) for camera module 12 to be able to detect whether there is a face or characteristic motion in the field of view of sensor 14 that indicates the presence of a user.

When camera module does not detect a face or character motion that indicates the presence of a user, camera module 12 may send a signal to software running on processing circuitry 24 to start the power saving process. Initially, the power saving process may include slowing down the frame rate of camera sensor 14 and turning off monitor or display components in host subsystem 20. After additional time, further power reduction steps can be taken to place device 10 into progressively lower power usage modes.

While processing circuitry 24 is running, device 10 can quickly recovery to full power operation upon receiving an interrupt from the camera module 12. The interrupt may indicate that either a face or characteristic motion has been detected, at which point device 10 can power back up. When host subsystem 20 receives an interrupt indicating that either a face or characteristic motion has been detected, device 10 can power back up. When the device 10 is fully functional automatically, imaging system 12 may be used by device 10 to perform face recognition and log in the user in a smooth and hands free manner.

It is also possible that device 10 can turn off a graphical processing unit (GPU) and/or central processing unit (CPU) to place device 10 into a full sleep or hibernate mode. As long as camera module 12 is still powered either by host subsystem 20 (e.g., via USB path 18) or via a battery capacitor, or other power source, camera module 12 can electronically initiate a restart of device 10 and thereby automatically return device 10 to full power operation based on detection of a user's face or characteristic motion indicating the presence of a user. This provides a convenient user interface and hands free operation for returning device 10 to full power operation from any number of power saving modes.

With one suitable arrangement, statistical data is computed by image processing circuitry 16 for auto exposure, auto white balance, auto focus, etc. of images captured by camera sensor 14. One of the statistics that may be calculated by imaging processing circuitry 16 (that is part of system-on-chip integrated circuit 15) is a set of zone average luminance values. An image captured by imaging sensor 14 may be divided into multiple zones, such as a grid of 4×4 or 5×5 zones, and the average luminance is computed for each zone by circuitry 16. A presence detection algorithm running on circuitry 16 may use the zone average luminance to determine if a user is present.

When device 10 goes into a sleep mode, a presence detection algorithm may be initiated on image processing circuitry 16. Presence detection may be performed at other times as well. The first image frame processed by the presence detection algorithm may be selected as a reference frame. The zone average luminance values of the reference frame are stored (e.g., in memory in integrated circuitry 15). For each subsequent frame, the absolute difference of each zone average luminance between the reference frame and the current frame may be computed by the presence detection algorithm. If the difference in any zone is significant, that zone may be marked as “changed”. The presence detection algorithm may determine if the difference in a zone is significant by comparing the difference for that zone to a threshold level (e.g., the absolute change in zone luminance may be measured). If desired, the presence detection algorithm may determine if the difference in a zone is significant by comparing the difference for that zone divided by the luminance value from the reference frame for that zone to a threshold level (e.g., the percentage change in zone luminance may be measured).

The presence detection algorithm running on circuitry 16 may use any number of criteria in determining when a user is present. With one suitable arrangement, the algorithm may calculate the total number of changed zones and the number of changed columns (e.g., the number of columns of zones in which at least one zone has been marked as changed). The algorithm may determine that a user is present whenever the number of changed zones in an image is between a lower threshold number and an upper threshold number and the number of changed columns in that image is greater than a threshold number of changed columns. With this type of arrangement, the presence detection algorithm may be able to avoid false detection, such as when a user walks by device 10 but does not move into a normal position for interacting with device 10, or when sudden lighting changes occur.

When a user walks by device 10 but not towards device 10, there will be some or even many changed zones, but it is not likely to have changed zones in enough columns to satisfy the algorithm's changed columns threshold requirement. In contrast, when a user comes back and sits in front of device 10, more columns will have changed zones.

By requiring that the number of changed zones is lower than the upper threshold number, false detections cause by sudden lighting changes may be avoided. When a user actually returns to device 10, there will be many changed zones but it is unlikely all the zones will change. But when sudden lighting changes occur, there will be a lot more zones, if not all zones, changed at once. Therefore, a low and a high threshold for the number of changed zones may be used in the presence detection algorithm to reduce false detections.

With one suitable arrangement, the reference frame may be updated periodically. This type of arrangement may help to reduce false detections based on long-term gradual lighting changes (e.g., the shift of sunlight).

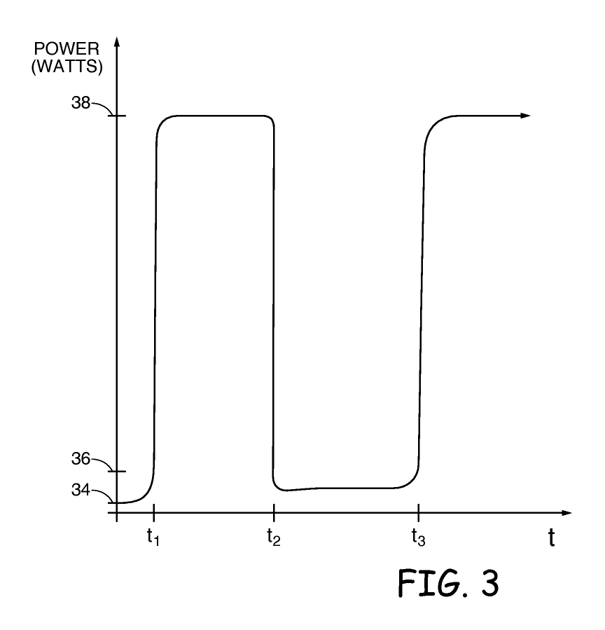

Illustrative steps involved with using imaging system 12 as part of regulating the power consumption of device 10 (FIG. 1) are shown in FIG. 2.

In step 28, device 10 may enter a power saving mode and imaging system 12 may begin or continue imaging operations. While device 10 is operating in the power saving mode, imaging system 12 may use camera sensor 14 to capture images and may use image processing circuitry 16 to perform imaging processing on the captured images. If desired, imaging system 12 may use camera sensor 14 to capture images at pre-defined intervals. Camera sensor 14 may capture an image every one-thirtieth of a second, every one-fifteenth of a second, every one-eighth of a second, every quarter-second, every half-second, every second, every two seconds, or at any other suitable interval.

With one suitable arrangement, while device 10 is operating in the power saving mode described in connection with FIG. 2, device 10 may shut down any desired components of host subsystem 20 while maintaining imaging system 12. With this type of arrangement, the power consumption of device 10 may be minimized, while simultaneously allowing imaging system 12 to continue operating.

In general, device 10 may shut down one or more components such as input-output devices 22 and storage and processing circuitry 24 as part of entering and operating in the power saving mode. As examples, when device 10 is entering or operating in the power saving mode, device 10 may shut down or reduce the power consumption of one or more processors, storage devices such as hard-disk drive storage devices, memory devices, display devices, communications devices, input-output devices, conventional imaging systems, image processing circuitry (in host subsystem 20), power converters, devices connected to device 10 (e.g., accessories and other devices that draw power from device 10 through input-output devices 22), other power-consuming devices in device 10, and combinations of these and other power-consuming devices. Power saving modes may sometimes be referred to herein as standby modes and hibernation modes.

With one suitable arrangement, host subsystem 20 of device 10 may maintain input-output circuitry associated with path 18 when device 10 is operating in a power saving mode. Host subsystem 20 may provide power to camera module 12 over path 18 and host subsystem 20 may listen for interrupts and other signals from camera module 12 over path 18. If desired, path 18 may be a universal serial bus (USB®) communications port and camera module 12 may be an external accessory connected to host subsystem 20 via USB path 18. When host subsystem 20 detects an interrupt on path 18, host subsystem 20 may awaken so that device 10 is no longer operating in the power saving mode.

Image processing circuitry 16 may process images from camera sensor 14 in step 28. As examples, circuitry 16 may analyze images from sensor 14 in a facial recognition process, a facial detection process, and/or a motion detection process. In the facial recognition process, circuitry 16 may analyze images and determine the identity of a user in the images from sensor 14. When a user is recognized, circuitry 16 may provide data to host subsystem 20 that indicates the presence of a user and that identifies the user. In the facial detection process, circuitry 16 may analyze images and determine if any users' faces are in the images from sensor 14. When a face is detected, circuitry 16 may provide data to host subsystem 20 that indicates that a user is present in the images from sensor 14. If desired, circuitry 16 and/or circuitry 24 may perform a facial recognition process on an image following a positive detection of the presence of a face in that image. In the motion detection process, circuitry 16 may analyze the images and determine if there is motion in the images (e.g., if there are differences between at least two frames that are indicative of motion) that exceeds a given threshold level. In response to a detection of motion above the given threshold level, circuitry 16 may provide data to host 20 that indicates the presence of motion. If desired, circuitry 16 may provide an interrupt (sometimes referred to flag) to host subsystem 20 in response to positive results from a facial detection process, a facial recognition process, or a motion detection process (in addition to or instead of more detailed processing results or processed images).

In step 30, device 10 may resume normal operations (after receiving an interrupt on path 18). With one suitable arrangement, imaging system 12 may generate an interrupt on path 18 in response to results of the image processing and image sensing operations performed in step 28. The interrupt may be received by host subsystem 20. In response to receiving the interrupt, host subsystem 20 may restore power to one or more components that were shut down in the power saving mode (e.g., host subsystem 20 may begin operating in a full power mode).

With this type of arrangement, device 10 can be awakened from its power conservation mode by imaging system 12. This type of arrangement may allow a user of device 10 to wake device 10 from a power saving mode simply by moving into the field of view of camera sensor 14, since imaging system 12 may analyze images from sensor 14 for the presence of a face and awaken device 10 when a face is detected. In addition, because the imaging processing occurs on circuitry 16, processors in host subsystem 20 are not required for this type of imaging processing and can be shut down, thereby decreasing the power consumption of device 10 while in the power saving mode.

If desired, the imaging sensing operations described in connection with step 28 may continue in step 30. With this type of arrangement, device 10 may enter a power saving mode in response to an extended negative result from the image sensing operations, as illustrated by line 32. For example, imaging system 12 may continue to capture images and analyze the images for the presence of a user's face and, if the imaging system 12 does not capture an image that includes a user's face for a given period of time (e.g., one minute, five minutes, ten minutes, thirty minutes, etc.), device 10 may automatically enter its power saving mode. Device 10 may also enter a power saving mode (as illustrated by line 32) when input-output devices 22 do not receive any user input for a given period of time (e.g., when a user of device 10 does not provide any user input for a preset period of time).

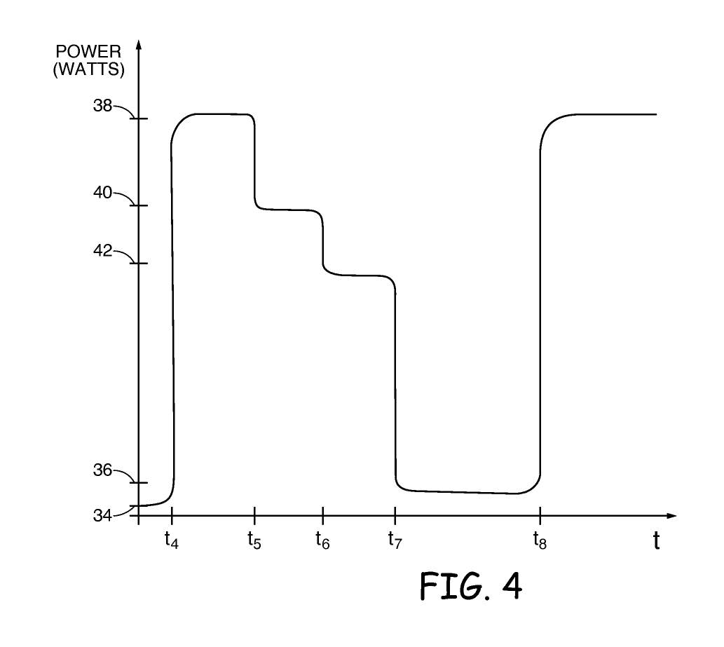

The power consumption of electronic device 10 in various power consumption modes is illustrated in the graphs of FIGS. 3 and 4.

As shown in FIG. 3, device 10 may be consuming power at power level 34 prior to time t₁. Prior to time t₁, device 10 may be turned off or operating in a power saving mode. With one suitable arrangement, power level 34 may represent the amount of power required to operate a power transformer in device 10. As an example, power level 34 may be less than four watts.

At time t₁, device 10 may begin operating in a regular power consumption mode (e.g., device 10 may turn on at time t₁). As circuitry in device 10 activates (awakens), the power consumption of device 10 may increase to power level 38. As one example, power level 38 may fluctuate around and average to approximately 24 watts (e.g., in embodiments in which device 10 is a laptop computer).

At time t₂, device 10 may enter a power saving mode in which imaging system 12 remains active (e.g., as in step 28 of FIG. 2). Because displays, processing circuitry, storage devices, and other components of host subsystem 20 can be turned off in the power saving mode, the power consumption of device 10 drops to power level 36. Power level 36 may be approximately four watts, as an example.

At time t₃, imaging system 12 detects a wake-up event and awakens device 10 from the power saving mode. As examples, imaging system 12 may be configured to awaken device 10 upon detection of wake-up event such as movement, a face, a particular face, or another suitable wake-up event in one or more images captured by imaging system 12 between times t₂ and t₃. As device 10 awakens from the power saving mode, the power consumption of device 10 again rises to power level 38.

FIG. 4 illustrates how device 10 may step through multiple power saving modes with decreasing power consumption levels as part of entering a power saving mode (e.g., as in step 28 of FIG. 2).

At time t₄, device 10 may turn on and the power consumption of device 10 may rise to power level 38.

At time t₅, device 10 may enter a first power saving mode and the power consumption of device 10 may fall to power level 40. As one example, device 10 may shut down or reduce the power consumption of devices in host subsystem 20. For example, device 10 may reduce the brightness of a display and initiate a power saving cycle at time t₅.

At time t₆, device 10 may enter a second power saving mode and the power consumption of device 10 may fall to power level 42. As one example, device 10 may shut down or reduce the power consumption of displays and other circuitry in host subsystem 20 while maintaining memory and other circuitry to enable device 10 to quickly resume normal operations.

At time t₇, device 10 may enter a third power saving mode such as the power saving mode of FIG. 3 and the power consumption of device 10 may fall to power level 36 (e.g., approximately 4 watts). Imaging system 12 may remain active at least from time t₅ to time t₈ so that imaging system 12 can awaken device 10 upon detection of a wake-up event.

At time t₈, imaging system 12 detects a wake-up event and awakens device 10. As device 10 awakens, the power consumption of device 10 may rise to power level 38. As one example, imaging system 12 may detect a user's return to device 10 (e.g., by detecting a user's face or the presence of a face) and may power up device 10 in response. If desired, facial detection may also be performed around time t₈ and the results of the facial detection may be used to automatically log a user whose face is recognized into device 10. With this type of arrangement, a user can awaken device 10 and log into software on device 10 simply by moving into the field of view of imaging system 12 and allowing imaging system 12 to recognize their face.

If desired, imaging system 12 may be used as part of an image-based positioning system (which may be referred to as an image-assisted positioning system). In an image-assisted positioning system, images captured by camera module 12 may be used to determine the location of device 10. For example, images captured by camera module 12 may be processed and compared to images in a database (referred to herein as database images). Each of the database images may include associated location information identifying where that database image was captured. When a match is found between an image captured by camera module 12 and a database image, the location information for that database image may be used by device 10 as the location of device 10.

The database images may be stored locally on device 10 or externally on other electronic devices or servers. Comparison of captured images and database images may occur locally or remotely (e.g., image comparison may be performed by one or more external servers).

Imaging system 12 may process captured images before the images are used in an image-assisted positioning system. For example, imaging system 12 may increase the contrast of captured images, convert captured images to black-and-white, or may perform other actions on captured images. These types of arrangements may be helpful in compressing captured images for use in an image-assisted positioning system.

With one suitable arrangement, information from a secondary positioning system may be used in conjunction with location information obtained from images captured by imaging system 12. As one example, location information from a global positioning system (GPS) or other positioning system may be used in focusing the comparison of captured images with database images. Image-assisted positioning systems may restrict the database images actually used in the comparison to those database images that are from locations in the vicinity of a location indentified by the secondary positioning system. If desired, image-assisted positioning systems may use the last known position from the secondary positioning system in selecting which database images to use first and, if no matches are found, may then expand the comparison to additional database images.

This type of arrangement may be used in extending the range of positioning systems that rely on external signals (e.g., cellular telephone signals or satellite-based positioning signals) to areas that the external signals do not reach such as inside buildings. This type of arrangement may sometimes be referred to as an image-assisted global positioning system or “indoor GPS.”

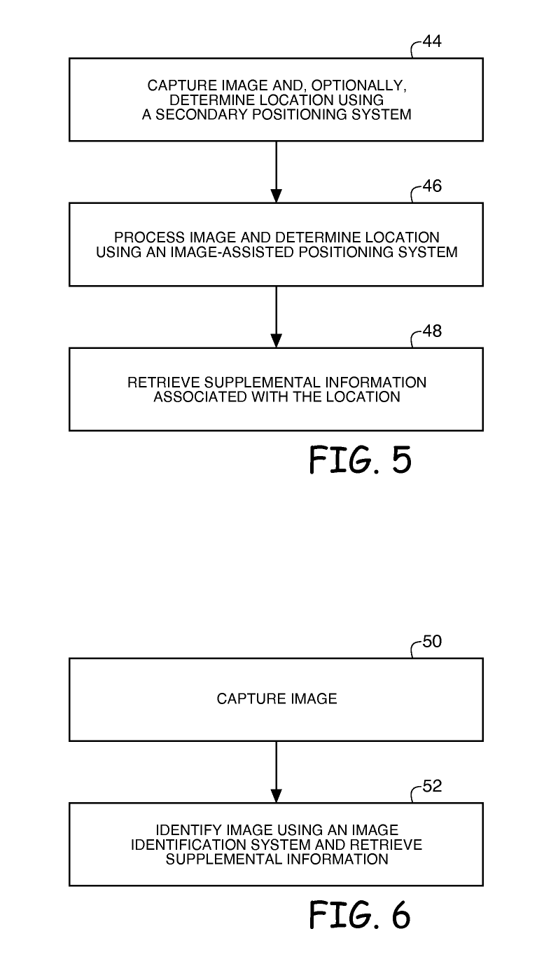

Illustrative steps involved in using device 10 and imaging system 12 as part of an image-assisted positioning system are shown in FIG. 5.

In step 44, device 10 may capture one or more images using imaging system 12. Optionally, device 10 may determine its location using a secondary positioning system such as position sensing circuitry 23 of FIG. 3 (e.g., GPS circuitry). If the secondary positioning system is currently unavailable (e.g., device 10 is out of range of signals used in the secondary positioning system), device 10 may use the last location information obtained by the secondary positioning system.

In step 46, imaging system 12 may process the captured image and determine the location of device 10 using an image-assisted positioning system. If desired, imaging system 12 may perform preprocessing and then convey the preprocessed image to host subsystem 20 over path 18 (FIG. 1). As examples, imaging system 12 may optimize the captured image for use in an image-assisted positioning system by compressing the image, by increasing the contrast of the image, by converting the image from color to black and white, using other techniques, and by using combinations of these and other techniques. Host subsystem 20 may compare the image to a database of images, each of which includes associated location information. If desired, host subsystem 20 may transmit the processed image to an external service for identification. Once a sufficient match is found between a database image and an image captured by camera module 12, the location associated with the matching database image is taken as the location of device 10.

Imaging system 12 may use image processing and data formatting circuitry 16 on integrated circuit 15 to compare the captured image to a database of images. With this type of arrangement, imaging system 12 may include a storage device such as memory in which a database of images is stored. If desired, the database of images stored in imaging system 12 may be a subset of a larger database of images stored in circuitry 24 or stored remotely. As one example, imaging system 12 may use location information from a secondary positioning system to select the subset of images stored in the storage device in imaging system 12.

In general, the position information obtained from the secondary positioning system (e.g., position sensing circuitry 23) may be less accurate than the position information obtained using the image-assisted positioning system described in connection with FIG. 5. For example, position sensing circuitry 23 may be able to tell that device 10 is inside of a particular building (e.g., because circuitry 23 last received a valid signal outside that building) but may be unable to tell which portion of the building device 10 is currently in (e.g., because circuitry 23 may require external signals that do not permeate the building). By using an image-assisting positioning system, device 10 may be able to determine its location inside of a building, by comparing images captured inside that building (e.g., images captured in step 44) to database images of the inside of that building. With this type of arrangement, the accuracy to which device 10 can determine its position is increased, especially in locations in which signals (e.g., GPS signal) required for operation of circuitry 23 are not available.

In optional step 48, device 10 may retrieve supplemental information associated with the location determined in step 46. The associated information may be retrieved from storage and processing circuitry 24 of device 10 and may be retrieved from storage on an external device or server accessed by device 10 through input-output devices 22. The information associated with the location determined in step 46 may include information such as text, additional images, audio, video, etc. As examples, host subsystem 20 may obtain a map of the location identified in step 46, a text description of the location, satellite and aerial images of the location, an audio narrative related to the location, video associated with the location, or other information, as desired.

With other suitable arrangements, device 10 may use processed images from circuitry 16 to identify an object, location, person, or other item in an image captured by sensor 14. Device 10 may then retrieve information on the identified object, location, person, or other item and provide that information to a user. This type of arrangement may sometimes be referred to as an image identification system. If desired, device 10 may use location information from a second positioning system such as GPS as part of identifying an object, location, person, or other item in an image captured by sensor 14. This type of arrangement may sometimes be referred to as a location-assisted image identification system.

Illustrative steps involved in using device 10 and imaging system 12 as part of an image identification and information retrieval system are shown in FIG. 6.

In step 50, device 10 may capture one or more images using imaging system 12. Optionally, device 10 may determine its location using a secondary positioning system such as GPS.

In step 52, imaging system 12 may use an image identification system to identify the image captured in step 50. Imaging system 12 and/or circuitry 24 may compare the captured image to a database of images to identify objects within the captured image, as one example. After the image is identified (e.g., one or more objects are identified in the image), imaging system 12 and device 10 may retrieve supplemental information associated with the image (e.g., supplemental information associated with the objects identified in the image). The supplemental information can include, as examples, encyclopedia entries associated with an identified object, translations of identified objects that include foreign language text, text transcriptions of identified objects containing text, etc. With another suitable arrangement, imaging system 12 may perform an optical character recognition (OCR) process on the captured image or may preprocess the captured image as preparation for performing an OCR process on the captured image using circuitry 24 of device 10 or external processing circuitry. With this type of arrangement, the supplemental information may be the results of the OCR process. In one example, a user of device 10 may capture an image of a object containing text in any language, process the image in an OCR process capable of reading text in multiple languages, obtain a translation of the text in the user's preferred language, and present the user with the translation of the text in the captured image.

As an example, imaging system 12 may capture an image of a movie poster in step 50. In step 52, the image identification system may identify which movie the movie poster is associated. Imaging processing circuitry 16 may process the image captured in step 50 to assist in the identification of step 52. For example, circuitry 16 may convert the captured image into black-and-white and/or may increase the contrast of the captured image. Once the movie has been identified, device 10 may retrieve relevant information on the movie (e.g., the movie's length, director, list of actors and actresses, running time, release date, reviews, ratings, etc.) and may display the information for the user of device 10 on a display device. If desired, device 10 may use position sensing circuitry 23 and/or may use the image-assisted positioning system of FIG. 5 to determine its current location. Once the position of device 10 is known, device 10 may retrieve position-related information on the identified movie such as show times for nearby theatres, addresses and maps to those theatres, addresses and maps to nearby movie businesses that may have the identified movie in stock for rental or purchase, etc.

Imaging systems (e.g., cameras and camera control circuits such as camera module 12) may be used for control of various functions of an electronic device. For example, imaging system 12 may control monitor (display) brightness and colorimetric settings (e.g., adjust brightness based on a user's position, ambient light conditions, and display screen conditions to minimize/optimize power consumption and to provide a “True Color” display, which may help to display more accurate images). If desired, an imaging system may be used in controlling a projector (e.g., by providing the projector with brightness settings, colorimetric settings, zoom settings, focus settings, and keystone settings).

An imaging system such as camera module 12 may control a display that is one of the input-output devices 22 of an electronic device 10. The imaging system may include one or more integrated circuits that execute software and that are linked to the monitor. As one example, the imaging system may include a system-on-chip (SOC) circuit that links to control software running on a processor in the electronic device. If desired, the system-on-chip circuit may have a data link to a video circuit in the electronic device (e.g., the SOC circuit may have a data link to a video card or circuit via a Southport connection in a personal computer to implement monitor control functions).

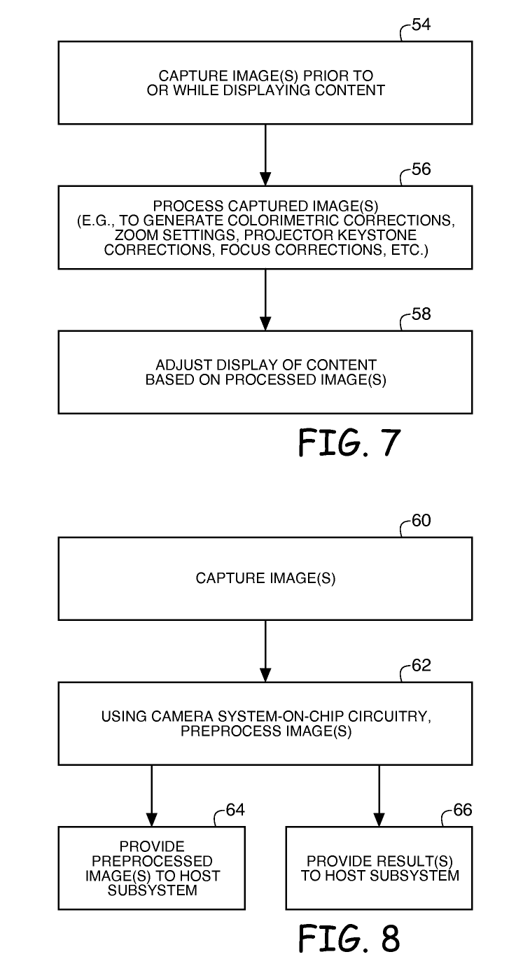

If desired, imaging system 12 may control a projection system (i.e., a projector). For example, input-output devices 22 of FIG. 1 may include a projection system with settings to adjust brightness, focus, zoom, keystone corrections, colorimetric corrections, and other projection parameters. Illustrative steps involved in using imaging system 12 to control a projection system are shown in FIG. 7.

In step 54, imaging system 12 may capture one or more images. With one suitable arrangement, imaging system 12 may capture images in the same direction that a projection system projects content. If desired, imaging system 12 may also capture images in other directions.

Imaging system 12 may capture one or more images while a projection system in input-output devices 22 is not projecting any content. Imaging system 12 may use images captured while content is not being projected to calculate baseline readings such as the brightness of the environment around device 10, the color, size, distance, and/or location of potential projection surfaces, etc.

In addition or alternatively, imaging system 12 may capture one or more images while the projection system is projecting content. The displayed content may be a specific pattern or image used in projector setup operations. In general, the displayed content may be any content the projection system is capable of displaying. If desired, the projection system may convey information on the projected content to imaging system 12 over path 18.

In step 56, imaging system 12 may process the captured images. In arrangements in which the projection system of input-output devices 22 conveys information on the content being projected to imaging system 12, imaging system 12 may compare that content to the captured images. In step 56, processing circuitry 16 may calculate at least one correction factor such as a focus correction factor, zoom correction factor, colorimetric correction factors, keystone correction factors, etc.

In step 58, imaging system 12 may provide the correction factors calculated in step 56 to the projection system in input-output device 22 over path 18. The projection system may use the correction factors to adjust the projection settings.

Based on the differences in the content being project and the captured images of the projected content, imaging system 12 may calculate correction factors to the projection system's settings to improve the quality of the projected content. As a first example, imaging system 12 may determine that the projected content is out of focus and may provide control signals (sometimes referred to as correction factors) to the projection system in input-output devices 22 over path 18 to direct the projection system to adjust its focus. As a second example, imaging system 12 may determine that current projection surface or ambient lighting conditions have skewed the colors of the projected content and may direct the projection system to compensate by adjusting colorimetric settings accordingly. In this second example, when imaging system 12 determines that the current projection surface is not ideal (e.g., the project surface is off-white or another color), imaging system 12 may calculate colorimetric correction factors that are used by the projection system to compensate for the lack of an ideal projection surface. With this of arrangement, the impact of having a non-ideal projection surface color is minimized (e.g., the projection system compensates so that the projected content appears as close as possible to how it would if the projection surface were ideal). As a third example, imaging system 12 may determine that the projected content is larger or smaller than the current projection surface and may direct the projection system to adjust zoom settings accordingly. As a fourth example, imaging system 12 may determine that the projection surface is situated such that the projected image is distorted and could be improved via keystone corrections. In this fourth example, imaging system 12 may image content being projected by the projection system. The content may be rectangular in shape but, due to the positioning of the projection surface, the content may be distorted vertically and/or horizontally when projected onto the projection surface. Imaging system 12 may determine the amount to which the content is distorted vertically and/or horizontally and provide correction factors to the projection system. The projection system may use the correction factors in adjusting keystone settings for correct for the distortions. In such situations, imaging system 12 may provide keystone correction control signals to the projection system in devices 22 over path 18. These examples are merely illustrative and, in general, imaging system 12 may provide any desired control signals to a projection system.

In general, imaging system 12 may capture and perform image preprocessing for host subsystem 20 for any desired purpose. Illustrative steps involved in using imaging system 12 to capture and perform image preprocessing are shown in FIG. 8.

In step 60, imaging system 12 may capture one or more images using camera sensor 14.

In step 62, image processing and data formatting circuitry 16 on integrated circuit 15 may performing image preprocessing (sometimes referred to herein as image processing). The image preprocessing performing by circuitry 16 may occur on an integrated system-on-chip such as integrated circuit 15 that includes an image sensor such as camera sensor 14.

In step 64, imaging system 12 may transmit the preprocess images captured in step 60 to host subsystem 20.

Alternatively or in addition to step 64, imaging system 12 may provide results of the image preprocessing (performed in step 62) to host subsystem 20 in step 66. For example, imaging system 12 may facilitate avatar applications such as for gaming and instant-messaging applications. In this example, imaging system 12 may provide animation control signals to host subsystem 20 that indicate how a user's face is moving and what facial expressions the user is making Host subsystem 20 may use the animation controls in animating an avatar (e.g., an animated creature whose motions are modeled after the motions captured by camera sensor 12 in step 60). In on-line sales applications (as well as other applications), the imaging system may capture a photo of the user as part of recording a purchase (e.g., to validate the user).

With one suitable arrangement, the preprocessing of step 62 may include gesture sensing. With this type of arrangement, image processing circuitry 16 may analyze images captured by image sensor 14 for the presence of certain gestures (e.g., without relying upon processing circuitry 24 of host subsystem 20). Imaging system 12 may provide the results of the gesture analysis (e.g., interrupts and controls associated with detected gestures) to host subsystem 20 in step 66.

With another suitable arrangement, the preprocessing of step 62 may include object tracking With this type of arrangement, imaging processing circuitry 16 may analyze images captured by image sensor 14 for the presence of objects to track. Imaging system 12 may provide the results of the object tracking analysis (e.g., object identification and tracking information such as the position and velocity of one or more objects) to host subsystem 20 in step 66.

Utilizing the capability of imaging system 12 to identify the presence of a face, selected objects, or motion can also be used to activate or call into operation other functions and programs while device 10 is in a full power operational mode. In this case, the ability of imaging system 12 to simultaneously operate in first mode of capturing pictures and in a second mode of identifying one or more aspects of the pictures allows imaging system 12 to minimize the amount of data host subsystem 20 and processing circuitry 24 are required to process to perform a function. As an example, face detection performed by the processing circuitry 24 of host subsystem 20 may require that the processing circuitry 24 process all the pixels in images provided by image sensor 14 (e.g., to determine, for every part of the image, whether the characteristics of a face are present).

In contrast, because imaging system 12 has the ability to scan, in real time, images and identify areas of those images that appear to have facial features, imaging system 12 may forward only those regions of the image that contain such features to host subsystem 20, greatly reducing the computing overhead of host subsystem 20. Further imaging system 12 can be designed to not forward images to the host subsystem 20 for facial detection unless the image contains such features, thereby further reducing the computational overhead and power host subsystem 20 requires to perform similar actions. Imaging system 12 also provides an optimization where imaging system 12 identifies frames of interest and selects sub-frames or windows with potentially viable content for an application running on processing circuitry 24, while the resources of host subsystem 20 can then be used to analyze the data forwarded by imaging system 12 to perform functions such as face recognition, object tracking and other applications when capabilities beyond those available within imaging system 12 are required.

Electronic device 10 may lower its power consumption by entering a power conservation mode, but may maintain power to imaging system 12 (e.g., via a USB port) so that imaging system 12 can reawaken electronic device 10. When imaging system 12 detects that a user has returned, imaging system 12 may generate an interrupt signal to awaken electronic device 10. Facial recognition (e.g., performed by imaging system 12 or by host subsystem 20) may then identify the user and log the user onto electronic device 10. This functionality may be automatic and hands free with relatively fast response times (e.g., electronic device 10 may power up and log on the user in approximately 8 seconds).

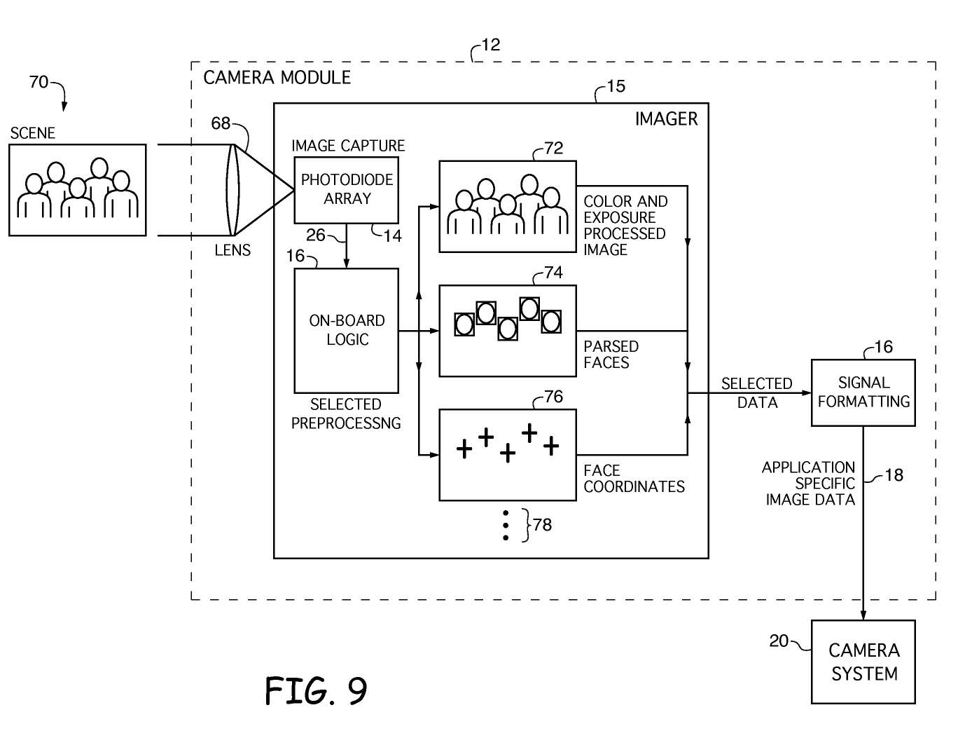

As discussed in connection with FIGS. 1-8, camera module 12 may capture images using camera sensor 14 and provide image data to host subsystem 20 over communications path 18. FIG. 9 illustrates arrangements in which camera module 12 can capture an image of a scene, perform image processing on the image, and provide application specific image data (e.g., processing image data) to camera system 20 (e.g., hot subsystem 20 of FIG. 1).

As shown in FIG. 9, lens 68 may focus light from scene 70 onto photodiode array 14 (e.g., camera sensor 14 of FIG. 1). Captured image data from array 14 may be conveyed to logic 16 (e.g., image processing circuitry 16 of FIG. 1) for image processing. The output of logic 16 may include color and exposure processed images such as image 72 (e.g., images whose color and/or exposure attributes have been optimized or adjusted by logic 16), parsed images (e.g., cropped images) such as image 74 (e.g., images in which only users' faces are included), processing results such as the coordinates of one or more objects in the images (e.g., the coordinates of faces in scene 70, illustrated by image 76), and other images, processed images, and processing results as illustrated by information 78 of FIG. 9.

The desired output of logic 16 (e.g., the “Selected Data” of FIG. 9) may be provided to signal formatting circuitry 16 (e.g., signal formatting circuitry that is part of data formatting circuitry 16 of FIG. 1). The output of logic and formatting circuitry 16 (e.g., the “Application Specific Image Data” of FIG. 9) may be provided to a host subsystem such as camera system 20.

The foregoing is merely illustrative of the principles of this invention and various modifications can be made by those skilled in the art without departing from the scope and spirit of the invention. The foregoing embodiments may be implemented individually or in any combination.

What is claimed is:

1. A method for reducing power consumption in an electronic device that has a host subsystem with circuitry and that has a camera module with an image sensor and image processing circuitry, wherein the host subsystem operates in a first mode in which the circuitry of the host subsystem is turned off and operates in a second mode in which the circuitry of the host subsystem is turned on, the method comprising:
while the host subsystem is operating in the first mode, capturing at least one image with the image sensor;
with the image processing circuitry, processing the image to determine whether a wake-up requirement has been satisfied; and
in response to determining that the wake-up requirement has been satisfied, sending a signal from the image processing circuitry to the host subsystem that causes the host subsystem to turn on the circuitry of the host subsystem and to switch from operating in the first mode to operating in the second mode.

2. The method defined in claim 1 wherein the host subsystem comprises a display, wherein the first mode is a standby mode, and wherein the second mode is a full power mode, the method further comprising:
when the host subsystem is operating in the standby mode, turning off the display; and
when the host subsystem switches from operating in the standby mode to operating in the full power mode, turning on the display.

3. The method defined in claim 1 wherein capturing the at least one image with the image sensor comprises capturing a plurality of images with the image sensor and wherein processing the image to determine whether the wake-up requirement has been satisfied comprises using the plurality of images to determine whether there is motion in the images.

4. The method defined in claim 1 wherein processing the image to determine whether the wake-up requirement has been satisfied comprises determining whether a user is present in the image.

5. The method defined in claim 4 wherein capturing the at least one image with the image sensor comprises capturing a reference image and a given image and wherein determining whether the user is present in the image comprises comparing the reference image to the given image to determine whether the user is present in the image.

6. The method defined in claim 5 wherein the reference image and the given image each comprise a plurality of zones arranged in a pattern of columns and rows, wherein each of the zones includes a plurality of pixels each of which has a luminance value, and wherein comparing the reference image to the given image to determine whether the user is present in the image comprises:
for each of the zones in the reference image and the given image, calculating a zone luminance value by summing together the luminance values of all of the pixels in that zone;
for each of the zones in the given image, determining if the difference between the luminance value of that zone and the luminance value of a respective one of the zones in the reference image is greater than a threshold value and, if the difference is greater than the threshold value, treating that zone as a changed zone;
determining whether the number of changed zones is between a first number and a second number, wherein the second number is greater than the first number and is less than the total number of zones in either the reference image or the given image; and
determining whether there is at least a third number of columns that include at least one changed zone.

7. The method defined in claim 4 further comprises:
in response to determining that the user is present in the image, sending the image in which the user is present from the image processing circuitry to the host subsystem; and
using the circuitry of the host subsystem, identifying the user.

8. The method defined in claim 1 wherein whether the wake-up requirement has been satisfied comprises:
with the image processing circuitry, determining whether a user is present in the image; and
with the image processing circuitry, determining whether the user is authorized to use the electronic device.

9. The method defined in claim 1 wherein capturing the at least one image with the image sensor while the host subsystem is operating in the first mode comprises capturing an image at least once every five seconds.

10. The method defined in claim 1 wherein the host subsystem comprises a display, volatile memory that holds data, and a nonvolatile storage device, the method further comprising:
placing the host subsystem in the first mode by moving the data in the volatile memory into the nonvolatile storage device and turning off the display, the volatile memory, the nonvolatile storage device, and the circuitry of the host subsystem.

11. A method of adjusting a projection system in an electronic device that has a camera module with an image sensor and image processing circuitry, the method comprising:
with the image sensor, capturing at least one image;
with the image processing circuitry, calculating at least one correction factor from the image; and
using the correction factor, adjusting at least one setting of the projection system selected from the group consisting of: a zoom setting, a focus setting, a colorimetric setting, and a keystone setting.

12. The method defined in claim 11 further comprising:
with the projection system, projecting content onto a projection surface, wherein capturing the at least one image with the image sensor comprises capturing an image of the content projected onto the projection surface.

13. The method defined in claim 12 wherein calculating the at least one correction factor with the image processing circuitry comprises comparing the image of the content that is being projected onto the projection surface and the content that is being projected by the projection system.

14. The method defined in claim 12 wherein the projection surface is positioned such that the content that is being projected is distorted along at least one of a vertical direction and a horizontal direction, wherein calculating the at least one correction factor with the image processing circuitry comprises calculating at least one keystone correction factor by determining how much the content that is being projected onto the projection surface has been distorted by the projection surface along at least one of the vertical direction and the horizontal direction, and wherein adjusting the at least one setting of the projection system comprises using the at least one keystone correction factor to adjust at least one keystone setting of the projection system.

15. The method defined in claim 11 wherein capturing the at least one image comprises capturing an image of a given projection surface on which the projection system is capable of projecting content and wherein calculating the at least one correction factor with the image processing circuitry comprises:
determining the color of the given projection surface; and
calculating at least one colorimetric correction factor based on the color of the given projection surface, the method further comprising:
with the projection system, using the at least one colorimetric correction factor to compensate for the color of the given projection surface.

16. A method of determining the location of an electronic device using an image-based positioning system, wherein the electronic device comprises position sensing circuitry that determines the position of the electronic device based on external signals and wherein the electronic device comprises an image sensor, the method comprising:
with the position sensing circuitry, determining that the electronic device has entered a given area in which the external signals are unavailable;
with the image sensor, capturing at least one image of the given area; and
with image processing circuitry and using a database of images of the given area, determining where the electronic device is located within the given area by comparing the image captured with the image sensor and the images in the database of images.

17. The method defined in claim 16 wherein each of the images in the database of images is associated with a particular location within the given area and wherein determining where the electronic device is located within the given area comprises:
identifying at least one object that is within both the image captured with the image sensor and a given one of the images in the database of images; and
identifying the particular location within the given area that is associated with the given one of the images in the database of images as the location of the electronic device within the given area.
